(19) United States
(12) Patent Application Publication
(10) Pub. No.: US 2017/0129778 A1
(43) Pub. Date: May 11, 2017

(54) CONVERSION OF GREENHOUSE GASES TO SYNTHESIS GAS BY DRY REFORMING

(71) Applicant: ECOKAP POWER LLC, Miami, FL (US)

(72) Inventors: Paul E. King, Albany, OR (US); Ben Zion Livneh, Denver, CO (US)

(21) Appl. No.: 15/228,904

(22) Filed: Aug. 4, 2016

Related U.S. Application Data
(60) Provisional application No. 62/202,770, filed on Aug. 7, 2015.

(51) Int. Cl. C01B 3/40; B01J 23/745; C10G 2/00; B01J 19/00; B01J 19/02; B01J 19/12; C01B 3/38; B01J 7/00

(52) U.S. Cl. CPC C01B 3/40; C01B 3/384; B01J 23/745; B01J 7/00; B01J 19/004; B01J 19/02; B01J 19/126; C10G 2/32; C01B 2203/0238; C01B 2203/062; C01B 2203/0855; C01B 2203/1241; C01B 2203/1258; C01B 2203/169; C01B 2203/1047; B01J 2219/00164; B01J 2219/0263; B01J 2219/0879; B01J 2219/1242

(57) ABSTRACT

A method for conversion of greenhouse gases comprises: introducing a flow of a dehumidified gaseous source of carbon dioxide into a reaction vessel; introducing a flow of a dehumidified gaseous source of methane into the reaction vessel; and irradiating catalytic material in the reaction vessel with microwave energy. The irradiated catalytic material is heated and catalyzes an endothermic reaction of carbon dioxide and methane that produces hydrogen and carbon monoxide. At least a portion of heat required to maintain a temperature within the reaction vessel is supplied by the microwave energy. If desired, a mixture that includes carbon monoxide and hydrogen can flow out of the reaction vessel and be introduced into a second reaction vessel to undergo catalyzed reactions producing multiple-carbon reaction products.

### BENEFIT CLAIMS TO RELATED APPLICATIONS

This application claims benefit of co-pending U.S. provisional Application No. 62/202,770 entitled “Conversion of greenhouse gases to synthesis gas by dry reforming” filed Aug. 7, 2015 in the names of Paul E. King and Ben Zion Livneh, said provisional application being hereby incorporated by reference as if fully set forth herein.

### FIELD OF THE INVENTION

The field of the present invention relates to greenhouse gas conversion. In particular, conversion of greenhouse gases to synthesis gas by dry reforming is disclosed herein.

### BACKGROUND

The subject matter of the present application may be related to subject matter disclosed in:
U.S. Pub. No. 2004/00031731 entitled “Process for the microwave treatment of oil sands and shale oils” published Feb. 19, 2004 in the names of Honeycutt et al;
U.S. Pub. No. 2007/0004809 entitled “Production of synthesis gas blends for conversion to methanol or Fischer-Tropsch liquids” published Jan. 4, 2007 in the names of Lattner et al;
U.S. Pub. No. 2010/0005720 entitled “Gasifier” published Jan. 14, 2010 in the names of Stadler et al;
U.S. Pub. No. 2010/0219107 entitled “Radio frequency heating of petroleum ore by particle susceptors” published Jan. 14, 2010 in the name of Parsche;
U.S. Pub. No. 2012/0055851 entitled “Method and apparatus for producing liquid hydrocarbon fuels from coal” published Mar. 8, 2012 in the name of Kyle;
U.S. Pub. No. 2012/0024843 entitled “Thermal treatment of carbonaceous materials” published Feb. 2, 2012 in the names of Lissiaski et al;
U.S. Pub. No. 2013/0303637 entitled “Method and apparatus for producing liquid hydrocarbon fuels from coal” published Nov. 14, 2013 in the name of Kyle;
U.S. Pub. No. 2014/0051775 entitled “Method and apparatus for producing liquid hydrocarbon fuels” published Feb. 20, 2014 in the name of Kyle;
U.S. Pub. No. 2014/0066526 entitled “Method and apparatus for producing liquid hydrocarbon fuels” published Mar. 6, 2014 in the name of Kyle;
U.S. Pub. No. 2014/0163120 entitled “Method and apparatus for producing liquid hydrocarbon fuels” published Jun. 12, 2014 in the name of Kyle;
U.S. non-provisional application Ser. No. 14/746,786 entitled “Method and apparatus for producing liquid hydrocarbon fuels” filed Jun. 22, 2015 in the name of Kyle;
U.S. Pub. No. 2014/0346030 entitled “Methods and apparatus for liquefaction of organic solids” published Nov. 27, 2014 in the name of Livneh;
U.S. Pub. No. 2014/0356246 entitled “Process and apparatus for converting greenhouse gases into synthetic fuels” published Dec. 4, 2014 in the name of Livneh;
U.S. Pat. No. 3,505,204 entitled “Direct conversion of carbonaceous material to hydrocarbons” issued Apr. 7, 1970 to Hoffman;
U.S. Pat. No. 4,435,374 entitled “Method of producing carbon monoxide and hydrogen by gasification of solid carbonaceous material involving microwave irradiation” issued Mar. 6, 1984 to Helm;
U.S. Pat. No. 5,266,175 entitled “Conversion of methane, carbon dioxide and water using microwave radiation” issued Nov. 30, 1993 to Murphy;
U.S. Pat. No. 8,779,013 entitled “Process and apparatus for converting greenhouse gases into synthetic fuels” issued Jul. 15, 2014 to Livneh;
of King et al;
GB 2096635 published Oct. 20, 1982 in the name of Tao;
WO 2008/009644 published Jan. 24, 2008 in the names of O'Connor et al;
Fidalgo et al; “Microwave-assisted dry reforming of methane”; Intl. J. Hydrogen Energy Vol 22 p 4337 (2008);
Fidalgo et al; “Syngas Production by CO₂ Reforming of CH₄ under Microwave Heating—Challenges and Opportunities”; Syngas: Production, Application and Environmental Impact, Indarto and Palguandi Eds. p 121 (2103); and
Hunt et al; Microwave-Specific Enhancement of the Carbon-Carbon Dioxide (Boudouard) Reaction”; J. Phys. Chem. C Vol 111 No 5 p 26871 (2013).
   Each one of those patents, publications, and applications is incorporated by reference as if fully set forth herein.

### SUMMARY

A method for conversion of greenhouse gases comprises: (a) introducing a flow of a dehumidified gaseous source of carbon dioxide into a reaction vessel; (b) introducing a flow of a dehumidified gaseous source of methane into the reaction vessel; and (c) irradiating catalytic material in the reaction vessel with microwave energy. The irradiated catalytic material is heated and catalyzes an endothermic reaction of the carbon dioxide and the methane that produces hydrogen and carbon monoxide. At least a portion of heat required to maintain a temperature within the reaction vessel is supplied by the microwave energy irradiating the catalytic material. If desired, a mixture that includes the carbon monoxide and the hydrogen can flow out of the reaction vessel and be introduced into a second reaction vessel to undergo catalyzed reactions producing one or more multiple-carbon reaction products.

Objects and advantages pertaining to dry reforming of greenhouse gases may become apparent upon referring to the example embodiments illustrated in the drawings and disclosed in the following written description or appended claims.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates schematically microwave-assisted catalyzed conversion of carbon dioxide and methane to carbon monoxide and hydrogen in a reaction vessel.

FIG. 2 illustrates schematically catalyzed conversion carbon monoxide and hydrogen into one or more multiple-carbon reaction products in a second reaction vessel.

The embodiments depicted are shown only schematically: all features may not be shown in full detail or in proper proportion, certain features or structures may be exaggerated relative to others for clarity, and the drawings should not be regarded as being to scale. The embodiments shown are only examples: they should not be construed as limiting the scope of the present disclosure or appended claims.

### DETAILED DESCRIPTION OF EMBODIMENTS

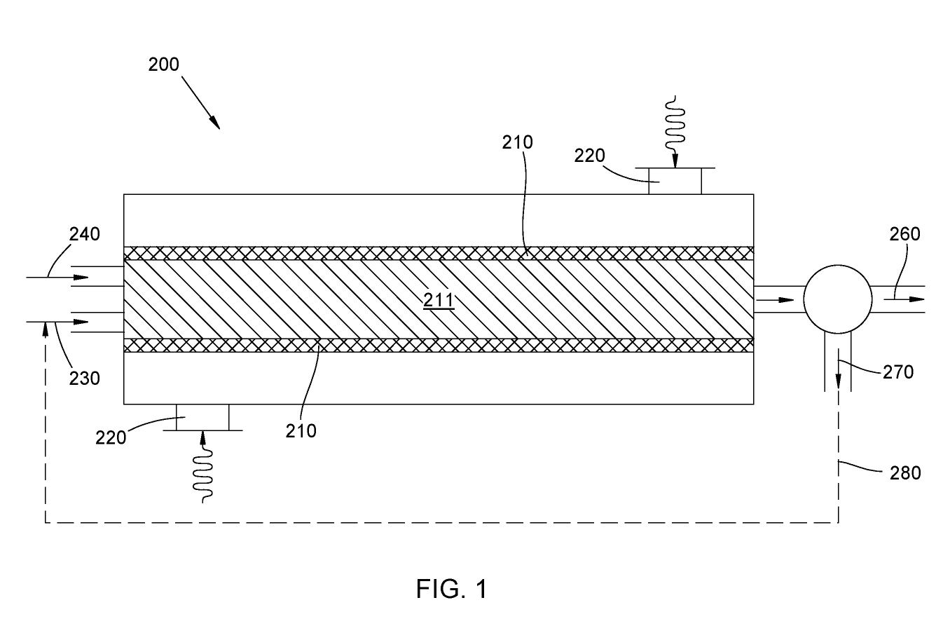

A method, for consuming carbon dioxide and generating carbon monoxide and hydrogen in a reaction vessel 200, is illustrated schematically in FIG. 1. A flow of a dehumidified gaseous source 230 of carbon dioxide enters the reaction vessel 200 through an input port, and a flow of a dehumidified gaseous source 240 of methane enters the reaction vessel 200 through an input port. Although separate ports are shown, the source gas flows 230/240 could instead be combined upstream and introduced into the reaction vessel 200 through a single port.

The reaction vessel 200 contains a catalytic material 211. Any suitable catalytic material can be employed in any suitable physical form, e.g., a packed bed, coated media of any suitable shape or form, a flowing fluidized particulate catalyst, and so on. Examples of suitable catalytic materials include catalysts based on, e.g., iron, cobalt, nickel, rhodium, ruthenium, platinum, palladium, or a combination of one or more catalytic materials. In one example, the catalytic material 211 is a packed bed that includes magnetite pellets intermixed with inert alumina pellets. The catalytic material 211 in the reaction vessel 200 is irradiated with microwave energy, thereby driving an endothermic reaction (catalyzed by the material 211) of the carbon dioxide and the methane to produce hydrogen and carbon monoxide (e.g., according to the dry gas reforming reaction CO₂+CH₄→2CO+H₂; other reactions or pathways might occur as well).

In the example shown, the reaction vessel 200 contains within its volume a quartz-lined passage 210 that contains the catalytic material 211. The quartz is substantially transparent to microwaves, and so acts as windows for transmitting the microwaves to propagate into the catalytic material 211. Any suitably strong and chemically compatible material that is substantially transparent to microwave radiation can be employed as window material or to contain the catalytic material 211 and the gases 230/240 flowing through it. Examples of suitable materials can include, but are not limited to, quartz, silica, zirconia, cordierite, alumina, and so forth. The microwaves enter the reaction vessel 200 through waveguides 220. The arrangement shown in FIG. 1 is only one example of a suitable arrangement for the reaction vessel 200, microwave-transmitting windows or containment, microwave waveguides, and so forth; myriad other suitable arrangements can be implemented within the scope of the present disclosure or appended claims. In some examples, there is no space between the passage 210 and the reaction vessel 200. In some other examples, there is no distinct passage 210, and the quartz or other microwave-transmitting material is present only where microwave waveguides 220 enter the reaction vessel 200.

For a given geometry of the reaction vessel 200 and the catalytic material 211, differing numbers or arrangements of the waveguides 220 can be employed, as well as differing relative amplitudes and phases, to obtain an optimized, or at least adequate, distribution of microwave energy within the catalytic material 211 in the reaction vessel 200. In the example shown, the microwave waveguides 220 are arranged on opposing sides of the reaction vessel 200 and offset from one another along a direction of flow through the reaction vessel 200. In that example arrangement, one suitable distribution of microwave energy within the reaction vessel 200 is obtained when the phases of microwave radiation entering the reaction vessel 200 through the waveguides 220 differ from each other by about a quarter of a period of the microwave radiation (i.e., a phase difference of about π/2). Other numbers and positions of waveguides 220, and corresponding relative phases of microwave energy emerging from those waveguides, can be employed. Microwave energy at any one or more frequencies, each with one or more corresponding relative phases, can be employed that results in adequate heating of the catalytic material 211. In some examples, the microwave energy is at one or more frequencies between about 300 MHz and about 10 GHz, e.g., frequencies within the so-called industrial, scientific, and medical (ISM) frequency bands; in some examples, the microwave energy is at one or more frequencies, e.g., between about 800 MHz and about 3 GHz, between about 2.4 GHz and about 2.5 GHz, between about 5 GHz and about 7 GHz, at about 915 MHz, or at about 896 MHz.

The conversion of carbon dioxide entering the reaction vessel 200 in the input gas stream 230 begins as the temperature in the reaction vessel 200 reaches about 400° C. (from heating of the catalytic material 211 by microwave irradiation; additional heating can be applied if need or desired). At that temperature, the conversion of carbon dioxide is around 40%. The carbon dioxide conversion rate increases to nearly 100% as the temperature increases from 400° C. to about 600° C. or 700° C. It is therefore useful to irradiate the catalytic material 211 only as much as necessary to maintain a temperature between about 600° C. and about 700° C. in the reaction vessel 200; any further heating beyond about 700° C. does not improve the carbon dioxide conversion rate, but might cause excessive heating and potential damage to the catalytic material 211 or the reaction vessel 200. Temperatures between about 400° C. and about 600° C. (e.g., greater than about 475° C.) can also be maintained, albeit with correspondingly lower conversion rates of CO₂. Note that the elevated temperature of the catalytic material 211 can be maintained without relying on heat produced by oxidation of the methane, which would reduce the net conversion of carbon dioxide by the reaction vessel 200. Pressures between about 1 atm and about 30 atm can be employed in the reaction vessel 200; in some examples pressures between about 1 atm and about 10 atm can be employed.

The carbon dioxide source gas 230 and the methane source gas 240 are dehumidified by any suitable method (e.g., by condensation on cooling elements using wet or dry cooling, refrigerant cooling, thermoelectric cooling, or cryogenic cooling, or by using a dry or wet desiccant) to reduce or substantially eliminate water from the input gas streams 230/240. Natural gas can be employed as the methane source gas 240, and is often sufficiently dehumidified without requiring a further dehumidification process; other methane source gases might contain more water and require dehumidification before introduction as the methane source gas stream 240. Depending on the origin of the carbon dioxide source gas 230, dehumidification of the source gas 230 before introducing it into the reaction vessel 200 might be required, if the source gas 230 is not sufficiently dehumidified to begin with. Preferably, water content of the gaseous carbon dioxide source 230 and the gaseous methane source 240 is less than about 2% by volume or less than about 1% by volume, and the water content of the combination of all gases entering the reaction vessel 200 is less than about 3% by volume or less than about 1% by volume. Within those ranges, water content can, if needed or desired, be controlled (by dehumidification) as a process parameter for controlling or optimizing the conversion of carbon dioxide. Note that the term “dehumidified” can refer to a source gas that has undergone a dehumidification process as part of the disclosed methods, or that has a sufficiently low water content as supplied without a requiring a separate dehumidification step. The degree to which one or both source gases are dehumidified can be selected, e.g., so as to achieve optimized conversion of carbon dioxide, or to achieve an acceptable level of carbon dioxide conversion while limiting the expense or energy consumption of any needed dehumidification process.

In some examples, the carbon dioxide source gas 230 is pure, or nearly pure, carbon dioxide; in many other examples, the carbon dioxide source gas 230 is not pure carbon dioxide, but will include other gases, typically inert gases. A common component of the carbon dioxide source gas 230 is nitrogen, which in some examples can be present in the carbon dioxide source gas 230 at non-zero levels up to about 80% by volume (e.g., greater than about 60% by volume, greater than about 70% by volume, or equal to about 78% by volume). The carbon dioxide conversion rates observed above were obtained at gas flow rates that resulted in residence times of the gases in the irradiated catalytic material 211 on the order of 100 milliseconds or less. The main effects of the presence of nitrogen (or other inert gas) is that it decreases the effective residence times of the carbon dioxide and methane in the catalytic material 211, and carries more heat away from the irradiated catalytic material 211. Both of those effects appear to be relatively minor, however. For example, higher microwave power can offset the heat carried away by the nitrogen flow.

The processes disclosed herein can be advantageously employed to convert carbon dioxide and methane, which are both potent greenhouse gases, into a higher-value mixture of carbon monoxide and hydrogen (i.e., synthesis gas, or syngas). A mixture that includes the carbon monoxide and the hydrogen to flows out of the reaction vessel 200. At least a portion of the carbon monoxide and hydrogen produced (syngas stream 260) can be separated from the stream 270 that can include unreacted (or regenerated) carbon dioxide, unreacted (or regenerated) methane, or other reaction byproducts. The processes disclosed herein can be operated so that less carbon dioxide leaves the reaction vessel 200 in the mixtures 260/270 than is introduced into the reaction vessel 200 in the source gas 230, so that a net decrease in atmospheric carbon dioxide occurs. To further reduce atmospheric carbon dioxide, at least a portion of carbon dioxide present in the mixture 270 can be recovered and reintroduced into the source gas stream 230 into the reaction vessel 200. If needed, that recovered carbon dioxide can be dehumidified (by any suitable method disclosed above) before its reintroduction into the source gas stream 230 into the reaction vessel 200.

Various plentiful sources of carbon dioxide can be employed to obtain the carbon dioxide source gas stream 230, including but not limited to combustion exhaust, biomass digestion (e.g., in the course of ethanol production), chemical processing byproducts (e.g., from hydrogen generation, production of lime or cement, ethylene production, or ammonia production), smelting or other mineral or ore processing, or any other natural or anthropogenic source of carbon dioxide. Some examples in which the carbon dioxide source gas stream 230 comprises combustion exhaust include flue gas produced by, e.g., an electrical generation facility (e.g., gas- or coal-fired) or a steam generation facility. Flue gas typically comprises about 60% or more (by volume) of nitrogen, about 10% or more (by volume) of carbon dioxide, and about 10% or more (by volume) of water vapor, with the remainder being oxygen and various trace gases (e.g., SO₂, SO₃, HCl, and so forth). Before introducing the flue gas into the reaction vessel 200 as the carbon dioxide source gas 230, it is dehumidified by any suitable process.

It has been observed that the reaction rate of carbon dioxide and methane in the reaction vessel 200 (as measured by carbon dioxide conversion) decreases over time as the reactant source gases 230/240 continue to flow into the input ports of the reaction vessel 200. It has been proposed that the decreased reaction rate might be due to so-called “coking” of the catalytic material 211 (i.e., deposition of elemental carbon on the catalytic material 211). Whatever, the mechanism for the decreased reaction rate, it has also been observed that interrupting the flow of the methane source gas 240 into the reaction vessel 200 causes the carbon dioxide conversion rate to increase. A proposed mechanism for the increase is reaction of carbon dioxide in the source gas 230 with elemental carbon deposited on the catalytic material (e.g., according to the Boudouard reaction C+CO₂→2CO). Whatever the mechanism, the methane source gas 240 can be reintroduced into the reaction chamber 200 and carbon dioxide conversion will resume at about its original rate. When the rate slows again, the interruption and resumption of methane flow can be repeated as needed to restore the reaction rate (presumably by restoration of activity of the catalytic material 211; restoration of the reaction rate by any known or unknown mechanism shall fall within the scope of the present disclosure or appended claims).

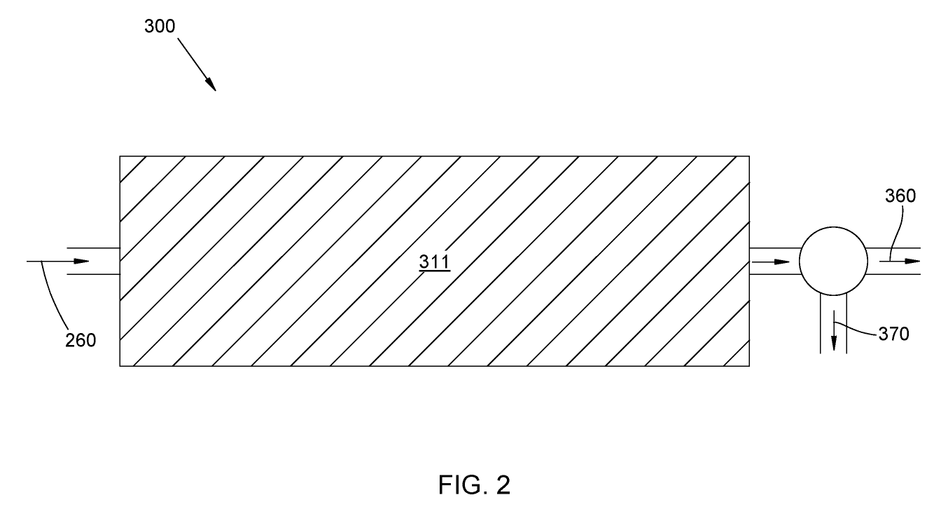

The carbon monoxide and hydrogen in the output stream 260 can be used for any suitable or desirable purpose, e.g., as feedstock for any number of chemical processes. In the example of FIG. 2, the output stream is be introduced into a separate, second reaction vessel 300. Other gases can be introduced into the reaction vessel 300 as well, as needed or desired, for modifying, modulating, or controlling reactive processes in the reaction vessel 300. The hydrogen and the carbon monoxide produced in the output stream 260 flows into the reaction vessel 300 containing a second catalytic material 311. As with the catalytic material 211, the second catalytic material 311 can comprise any suitable catalytic material provided in any suitable physical form, e.g., a packed bed, coated media of any suitable shape or form, a flowing fluidized particulate catalyst, and so on. In one example, the catalytic material 311 is a packed bed that includes magnetite pellets intermixed with inert alumina pellets.

The second catalytic material 311 in the reaction vessel 300 catalyzes exothermic reactions involving the carbon monoxide and the hydrogen to produce one or more multiple-carbon reaction products (i.e., organic compounds containing two or more carbon atoms). The reactions occurring in the reaction vessel 300 can include myriad different reactions occurring in parallel or in sequence; many of the reactions may fall within the general category of Fischer-Tropsch processes, however, any pertinent reactions or mechanisms shall fall within the scope of the present disclosure or appended claims. A product mixture exits the reaction vessel 300 and can include unreacted (or regenerated) carbon dioxide or methane, unreacted (or regenerated) carbon monoxide or hydrogen, one or more multiple-carbon reaction products, or other reaction byproducts. At least a portion of the one or more multiple-carbon reaction products 360 can be separated from the remainder 370 of the product mixture. The one or more multiple-carbon reaction products 360 can include one or more of: (i) one or more linear or branched-chain aliphatic hydrocarbons (i.e., alkanes, alkenes, or alkynes), (ii) one or more linear or branched-chain aliphatic primary alcohols, (iii) one or more linear or branched-chain aliphatic aldehydes or ketones; (iv) one or more linear or branched-chain aliphatic carboxylic acids, (v) one or more linear or branched-chain aliphatic esters, (vi) one or more linear or branched-chain aliphatic acid anhydrides, or (vii) other multiple-carbon organic compounds. Reaction conditions (e.g., temperatures and pressure) in the reaction vessel 300 as well as composition and flow rate of the input reactant gas flows can be altered or optimized to obtain various desired distributions of product compounds. For example, pressures between about 1 atm and about 30 atm can be employed; in some examples pressures between about 15 atm and about 25 atm, or at about 20 atm, can be employed.

The reaction vessel 300 typically is maintained at a lower temperature than the reaction vessel 200. If needed or desired, a cooling jacket or other cooling apparatus can be employed. Lower temperature conditions favor production of longer-chain products of Fischer-Tropsch processes. The cooling apparatus is used to keep the reaction vessel portion 300, and the catalytic material 311 in it, below about 350° C. Any suitable type of cooling can be employed, including but not limited to a water-cooled jacket, piping, or coils, wet or dry cooling, other coolant-based refrigeration, thermoelectric cooling, cryogenic cooling, and so forth.

In addition to the preceding, the following examples fall within the scope of the present disclosure or appended claims:

### Example 1

A method for generating a mixture of carbon monoxide and hydrogen, the method comprising: (a) introducing a flow of a dehumidified gaseous source of carbon dioxide into a reaction vessel; (b) introducing a flow of a dehumidified gaseous source of methane into the reaction vessel; (c) irradiating catalytic material in the reaction vessel with microwave energy so as to heat the catalytic material and drive an endothermic reaction of the carbon dioxide and the methane, catalyzed by the catalytic material, that produces hydrogen and carbon monoxide, wherein at least a portion of heat required to maintain a temperature within the reaction vessel is supplied by the microwave energy irradiating the catalytic material in the reaction vessel; and (d) allowing a mixture that includes the carbon monoxide and the hydrogen to flow out of the reaction vessel.

### Example 2

The method of Example 1 further comprising dehumidifying the gaseous source of carbon dioxide or the gaseous source of methane before introduction into the reaction vessel.

### Example 3

The method of any one of Examples 1 or 2 further comprising separating at least a portion of the carbon monoxide and the hydrogen from the mixture that leaves the reaction vessel.

### Example 4

The method of any one of Examples 1 through 3 wherein the water content of the gaseous source of carbon dioxide and the gaseous source of methane is (i) less than about 2% by volume or (ii) less than about 1% by volume.

### Example 5

The method of any one of Examples 1 through 4 wherein water content of a combination of all gases entering the reaction vessel is (i) less than about 3% by volume, (ii) less than about 2% by volume, or (iii) less than about 1% by volume.

### Example 6

The method of any one of Examples 1 through 5 wherein the gaseous source of carbon dioxide includes a non-zero amount of nitrogen (i) up to about 80% nitrogen by volume, (ii) greater than about 60% nitrogen by volume, (iii) greater than about 70% nitrogen by volume, or (iv) about equal to 78% nitrogen by volume.

### Example 7

The method of any one of Examples 1 through 6 wherein less carbon dioxide leaves the reaction vessel in the mixture than is introduced into the reaction vessel.

### Example 8

The method of any one of Examples 1 through 7 further comprising recovering from the mixture that leaves the reaction vessel at least a portion of carbon dioxide present in that mixture, and reintroducing the recovered carbon dioxide into the reaction vessel.

### Example 9

The method of Example 8 further comprising dehumidifying the recovered carbon dioxide before reintroduction into the reaction vessel.

### Example 10

The method of any one of Examples 1 through 9 further comprising maintaining the reaction vessel at a temperature (i) between about 400° C. and about 600° C., (ii) above about 475° C., or (iii) between about 600° C. and about 700° C.

### Example 11

The method of any one of Examples 1 through 10 wherein temperature within the reaction vessel is maintained without relying on heat produced by oxidation of the methane.

### Example 12

The method of any one of Examples 1 through 11 wherein the gaseous source of carbon dioxide comprises combustion exhaust.

### Example 13

The method of Example 12 further comprising dehumidifying the combustion exhaust before introducing the combustion exhaust into the reaction vessel.

### Example 14

The method of any one of Examples 12 or 13 wherein the combustion exhaust comprises flue gas from an electrical or steam generation facility.

### Example 15

The method of any one of Examples 1 through 14 wherein the gaseous source of methane comprises natural gas.

### Example 16

The method of any one of Examples 1 through 15 wherein the reaction vessel includes one or more windows comprising one or more materials that transmit the microwave energy, and the microwave energy irradiating the catalytic material in the reaction vessel passes through the one or more windows.

### Example 17

The method of any one of Examples 1 through 16 wherein the reaction vessel includes one or more of quartz, silica, zirconia, cordierite, or alumina.

### Example 18

The method of any one of Examples 1 through 17 wherein the microwave energy is introduced into the reaction vessel through a pair of microwave waveguides, the microwave waveguides are arranged on opposing sides of the reaction vessel and offset from one another along a direction of flow through the reaction vessel, and phases of microwave radiation entering the reaction vessel from the waveguides differ from each other by about a quarter of a period of the microwave radiation.

### Example 19

The method of any one of Examples 1 through 18 wherein the catalytic material includes one or more of iron, cobalt, nickel, rhodium, ruthenium, platinum, palladium, other one or more suitable catalytic materials, or combinations thereof.

### Example 20

The method of any one of Examples 1 through 19 wherein the catalytic material includes magnetite.

### Example 21

The method of any one of Examples 1 through 20 further comprising introducing at least a portion of the mixture that leaves the reaction vessel into a second reaction vessel containing a second catalytic material, wherein the second catalytic material in the second reaction vessel catalyzes exothermic reactions involving the carbon monoxide and the hydrogen to produce one or more multiple-carbon reaction products.

### Example 22

The method of Example 21 wherein the one or more multiple-carbon reaction products includes one or more of: (i) one or more linear or branched-chain aliphatic hydrocarbons, (ii) one or more linear or branched-chain aliphatic primary alcohols, (iii) one or more linear or branched-chain aliphatic aldehydes or ketones; (iv) one or more linear or branched-chain aliphatic carboxylic acids, (v) one or more linear or branched-chain aliphatic esters, or (vi) one or more linear or branched-chain aliphatic acid anhydrides.

### Example 23

The method of any one of Examples 1 through 22 further comprising: (i) upon observing a decrease in a rate of carbon dioxide conversion in the reaction vessel, interrupting the flow of the gaseous source of methane into the reaction vessel, and (ii) upon observing an increase in the rate of carbon dioxide conversion in the reaction vessel after interrupting the flow of the gaseous source of methane into the reaction vessel, restoring the flow of the gaseous source of methane into the reaction vessel.

### Example 24

The method of any one of Examples 1 through 23 wherein the microwave energy is at one or more frequencies: (i) between about 300 MHz and about 10 GHz; (ii) within the so-called industrial, scientific, and medical (ISM) radio bands; (iii) between about 800 MHz and about 3 GHz; (iv) between about 2.4 GHz and about 2.5 GHz; (v) between about 5 GHz and about 7 GHz; (vi) at about 915 MHz; or (vii) at about 896 MHz.

It is intended that equivalents of the disclosed example embodiments and methods shall fall within the scope of the present disclosure or appended claims. It is intended that the disclosed example embodiments and methods, and equivalents thereof, may be modified while remaining within the scope of the present disclosure or appended claims.

In the foregoing Detailed Description, various features may be grouped together in several example embodiments for the purpose of streamlining the disclosure. This method of disclosure is not to be interpreted as reflecting an intention that any claimed embodiment requires more features than are expressly recited in the corresponding claim. Rather, as the appended claims reflect, inventive subject matter may lie in less than all features of a single disclosed example embodiment. Thus, the appended claims are hereby incorporated into the Detailed Description, with each claim standing on its own as a separate disclosed embodiment. However, the present disclosure shall also be construed as implicitly disclosing any embodiment having any suitable set of one or more disclosed or claimed features (i.e., a set of features that are neither incompatible nor mutually exclusive) that appear in the present disclosure or the appended claims, including those sets that may not be explicitly disclosed herein. In addition, for purposes of disclosure, each of the appended dependent claims shall be construed as if written in multiple dependent form and dependent upon all preceding claims with which it is not inconsistent. It should be further noted that the scope of the appended claims does not necessarily encompass the whole of the subject matter disclosed herein.

For purposes of the present disclosure and appended claims, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless: (i) it is explicitly stated otherwise, e.g., by use of “either . . . or,” “only one of,” or similar language; or (ii) two or more of the listed alternatives are mutually exclusive within the particular context, in which case “or” would encompass only those combinations involving non-mutually-exclusive alternatives. For purposes of the present disclosure and appended claims, the words “comprising,” “including,” “having,” and variants thereof, wherever they appear, shall be construed as open ended terminology, with the same meaning as if the phrase “at least” were appended after each instance thereof, unless explicitly stated otherwise.

In the appended claims, if the provisions of 35 USC §112(f) are desired to be invoked in an apparatus claim, then the word “means” will appear in that apparatus claim. If those provisions are desired to be invoked in a method claim, the words “a step for” will appear in that method claim. Conversely, if the words “means” or “a step for” do not appear in a claim, then the provisions of 35 USC §112(f) are not intended to be invoked for that claim.

If any one or more disclosures are incorporated herein by reference and such incorporated disclosures conflict in part or whole with, or differ in scope from, the present disclosure, then to the extent of conflict, broader disclosure, or broader definition of terms, the present disclosure controls. If such incorporated disclosures conflict in part or whole with one another, then to the extent of conflict, the later-dated disclosure controls.

The Abstract is provided as required as an aid to those searching for specific subject matter within the patent literature. However, the Abstract is not intended to imply that any elements, features, or limitations recited therein are necessarily encompassed by any particular claim. The scope of subject matter encompassed by each claim shall be determined by the recitation of only that claim.

What is claimed is:

1. A method for generating a mixture of carbon monoxide and hydrogen, the method comprising:
(a) introducing a flow of a dehumidified gaseous source of carbon dioxide into a reaction vessel;
(b) introducing a flow of a dehumidified gaseous source of methane into the reaction vessel;
(c) irradiating catalytic material in the reaction vessel with microwave energy so as to heat the catalytic material and drive an endothermic reaction of the carbon dioxide and the methane, catalyzed by the catalytic material, that produces hydrogen and carbon monoxide, wherein at least a portion of heat required to maintain a temperature within the reaction vessel is supplied by the microwave energy irradiating the catalytic material in the reaction vessel; and
(d) allowing a mixture that includes the carbon monoxide and the hydrogen to flow out of the reaction vessel.

2. The method of claim 1 further comprising separating at least a portion of the carbon monoxide and the hydrogen from the mixture that leaves the reaction vessel.

3. The method of claim 1 further comprising dehumidifying the gaseous source of carbon dioxide or the gaseous source of methane before introduction into the reaction vessel.

4. The method of claim 1 wherein the water content of the gaseous source of carbon dioxide and the gaseous source of methane is less than about 2% by volume.

5. The method of claim 1 wherein water content of a combination of all gases entering the reaction vessel is less than about 3% by volume.

6. The method of claim 1 wherein the gaseous source of carbon dioxide includes a non-zero amount of nitrogen up to about 80% nitrogen by volume.

7. The method of claim 1 wherein less carbon dioxide leaves the reaction vessel in the mixture than is introduced into the reaction vessel.

8. The method of claim 1 further comprising recovering from the mixture that leaves the reaction vessel at least a portion of carbon dioxide present in that mixture, and reintroducing the recovered carbon dioxide into the reaction vessel.

9. The method of claim 8 further comprising dehumidifying the recovered carbon dioxide before reintroduction into the reaction vessel.

10. The method of claim 1 further comprising maintaining the reaction vessel at a temperature above about 475° C.

11. The method of claim 1 wherein temperature within the reaction vessel is maintained without relying on heat produced by oxidation of the methane.

12. The method of claim 1 wherein the gaseous source of carbon dioxide comprises combustion exhaust.

13. The method of claim 12 further comprising dehumidifying the combustion exhaust before introducing the combustion exhaust into the reaction vessel.

14. The method of claim 12 wherein the combustion exhaust comprises flue gas from an electrical or steam generation facility.

15. The method of claim 1 wherein the gaseous source of methane comprises natural gas.

16. The method of claim 1 wherein the reaction vessel includes one or more windows comprising one or more materials that transmit the microwave energy, and the microwave energy irradiating the catalytic material in the reaction vessel passes through the one or more windows.

17. The method of claim 1 wherein the reaction vessel includes one or more of quartz, silica, zirconia, cordierite, or alumina.

18. The method of claim 1 wherein the microwave energy is introduced into the reaction vessel through a pair of microwave waveguides, the microwave waveguides are arranged on opposing sides of the reaction vessel and offset from one another along a direction of flow through the reaction vessel, and phases of microwave radiation entering the reaction vessel from the waveguides differ from each other by about a quarter of a period of the microwave radiation.

19. The method of claim 1 wherein the catalytic material includes magnetite.

20. The method of claim 1 further comprising introducing at least a portion of the mixture that leaves the reaction vessel into a second reaction vessel containing a second catalytic material, wherein the second catalytic material in the second reaction vessel catalyzes exothermic reactions involving the carbon monoxide and the hydrogen to produce one or more multiple-carbon reaction products.

21. The method of claim 20 wherein the one or more multiple-carbon reaction products includes one or more of: (i) one or more linear or branched-chain aliphatic hydrocarbons, (ii) one or more linear or branched-chain aliphatic primary alcohols, (iii) one or more linear or branched-chain aliphatic aldehydes or ketones; (iv) one or more linear or branched-chain aliphatic carboxylic acids, (v) one or more linear or branched-chain aliphatic esters, or (vi) one or more linear or branched-chain aliphatic acid anhydrides.

22. The method of claim 1 further comprising: (i) upon observing a decrease in a rate of carbon dioxide conversion in the reaction vessel, interrupting the flow of the gaseous source of methane into the reaction vessel, and (ii) upon observing an increase in the rate of carbon dioxide conversion in the reaction vessel after interrupting the flow of the gaseous source of methane into the reaction vessel, restoring the flow of the gaseous source of methane into the reaction vessel.
